(19) United States
(12) Patent Application Publication
(10) Pub. No.: US 2013/0332561 A1
(43) Pub. Date: Dec. 12, 2013

(54) Control of Collaboration Workspaces and Information Objects using Business Rules

(71) Applicants: Andrew R. Jones, Round Rock, TX (US); Gregory J. Boss, Saginaw, MI (US); C. Steven Lingafelt, Durham, NC (US); Kevin C. McConnell, Austin, TX (US); John E. Moore, JR., Brownsburg, IN (US)

(72) Inventors: Andrew R. Jones, Round Rock, TX (US); Gregory J. Boss, Saginaw, MI (US); C. Steven Lingafelt, Durham, NC (US); Kevin C. McConnell, Austin, TX (US); John E. Moore, JR., Brownsburg, IN (US)

(73) Assignee: INTERNATIONAL BUSINESS MACHINES CORPORATION, Armonk, NY (US)

(21) Appl. No.: 13/493,088

(22) Filed: Jun. 11, 2012

(51) Int. Cl. G06F 15/16

(52) U.S. Cl. 709/217

(57) ABSTRACT

An embodiment of the invention provides a method for sending a data object to an endpoint, wherein rules are added to the data object with a processor. The rules include a requisite endpoint attribute and/or a requisite user attribute of the endpoint, and wherein the requisite user attribute of the endpoint includes an approved role. The data object is sent to the endpoint with a communications module; and a rule-analyzing module determines whether the endpoint satisfies the rules. If the endpoint satisfies a threshold number of rules, the data object is received, stored in a memory device, and/or displayed on a display at the endpoint. The processor changes at least one of the rules after a threshold period of time that the data object is created, sent, and/or received.

### BACKGROUND

The present invention is in the field of systems, methods, and computer program products for control of collaboration workspaces and information objects using business rules.

Sharing of computer based information has become common place with today's technology. Very often links or copies of data (e.g., presentations, files, URLs, pictures, etc.) are sent and shared. This information is often put in emails and calendar invitations and used to drive meetings and work. In some cases, multiple information objects are bundled together and shared as a unit.

### SUMMARY OF THE INVENTION

An embodiment of the invention provides a method for sending a data object to an endpoint, wherein rules are added to the data object with a processor. The rules include a requisite endpoint attribute and/or a requisite user attribute of the endpoint, and wherein the requisite user attribute of the endpoint includes an approved role. The data object is sent to the endpoint with a communications module; and a rule-analyzing module determines whether the endpoint satisfies the rules. If the endpoint satisfies a threshold number of rules, the data object is received, stored in a memory device, and/or displayed on a display at the endpoint. The processor changes at least one of the rules after a threshold period of time that the data object is created, sent, and/or received.

Another embodiment of the invention provides a method for sending a data object to an endpoint, wherein the data object includes rules, and wherein the rules include a requisite endpoint attribute and/or a requisite user attribute of the endpoint. A rule-analyzing module determines whether the endpoint satisfies the rules. When the endpoint satisfies a threshold number of rules, the data object is received with a receiver, stored in a memory device, and/or displayed on a display at the endpoint. When the endpoint fails to satisfy the threshold number of rules, a rule that the endpoint failed to satisfy and/or instructions to be performed in order to satisfy the rule that the endpoint failed to satisfy are received. After a threshold period of time after the data object is created, sent to the endpoint, and/or received by the endpoint, the data object is deleted, modifying, copied, and/or sent.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a preparation phase according to an embodiment of the invention;

FIG. 2 is a flow diagram illustrating an operational phase according to an embodiment of the invention;

FIG. 3 is a flow diagram illustrating a method for sending a data object to an endpoint according to an embodiment of the invention;

FIG. 4 illustrates a system for sending a data object to an endpoint according to an embodiment of the invention;

FIG. 5 illustrates a computer program product according to an embodiment of the invention;

FIG. 6 depicts a cloud computing node according to an embodiment of the present invention;

FIG. 7 depicts a cloud computing environment according to an embodiment of the present invention; and

FIG. 8 depicts abstraction model layers according to an embodiment of the present invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention includes a method for sending an object to one or more endpoints, wherein the object is tagged with an extensible set of security attributes and associated rules, which are interrogated (analyzed) at each endpoint. Based on the interrogation and the endpoint's attributes, differing actions can be taken, for example, receiving the object, viewing the object, etc.

An embodiment of the invention provides a system and method for evaluating the appropriateness of the endpoint to receive and render information (also referred to herein as an “object”, “information object”, or a “data object”) based on one or more business rules. The information can be a single document, a collection of documents, a collaboration work space, and/or a collaboration work space including collaboration meta information.

In at least one embodiment, the business rules include rules such as the following example rules. The first example rule specifies that the endpoint's operating system (OS) must be of a specific version and/or patch level. The second example rule specifies that the endpoint must have a functioning antivirus application and/or must have a rules set (e.g., definition set) of no less than a threshold time period old (e.g., 1 day). The third example rule specifies that the endpoint must be attached via a wired connection to a network (e.g., a corporate intranet). The fourth example rule specifies that the endpoint must be using a virtual private network (VPN) tunnel that is terminated at a specific remote access server. The fifth example rule specifies that the endpoint's user must have authenticated to a central server. The sixth example rule specifies that the endpoint cannot have both an active connection to the internet and an active connection to a non-internet network (e.g., a corporate intranet). The seventh example rule specifies that the endpoint must be registered with a device registration database. The eighth example rule specifies that the endpoint must be of a specific physical type. The ninth example rule specifies that the endpoint must be a multi-threaded system. This can improve security by allowing security agents to run at the same time as other applications. The tenth example rule specifies that the owner, operator, and/or registered operator of the endpoint (also referred to herein as the “user”) must be of a specific role (e.g., within the Enterprise), such as an administrator. The eleventh example rule specifies that the owner/operator of the endpoint must have signed a non-disclosure agreement. The twelfth example rule specifies that the owner/operator of the endpoint must be a citizen of a specific country.

The business rules can change based on passage of time or after a date has passed. Furthermore, combinations of the example rules can be implemented (e.g., first and fourth example rules; second, third, and fifth example rules; sixth and twelfth example rules). In at least one embodiment, the rules are stored in a central database by the system operator. In another embodiment, the rules are stored in a distributed database. Thus, when the object is sent to the endpoint, the object can be tagged with an extensible set of security attributes and associated rules, wherein the rules are distributed with the object. In yet another embodiment, the rules are stored in a memory device resident on the endpoint.

If the endpoint “passes” a threshold number (e.g., 1) of specified business rules (e.g., rules 1-4, 7, and 9-11), the information can be received and/or displayed. At least one embodiment of the invention provides the following extensions to this basic use case. In some circumstances, the information may not be received into the endpoint until one or more specific business rules are satisfied (e.g., rules 5; rules 1-3). In other circumstances, the information may be received into the endpoint, but not displayed until certain business rules are satisfied. In some circumstances, the information may be received, encrypted, and stored on the endpoint, but not displayed until certain business rules are satisfied. In other circumstances, after a period of time has passed since the creation of the information object, and/or if the current date/time is after a predefined date/time, then the business rule that specifies if the information can be either received and/or displayed changes. In some circumstances, after a period of time has passed since the creation of the information object or since the reception of the information object by the receiver, the information object is deleted. In other circumstances, the information may be viewed, but forwarding or replying to the information is prohibited to any email address or a defined scope, such as all external addresses or only to members of a defined group of users in a directory. In some circumstance, the information may be modified, copied, and/or forwarded after a defined date. In other circumstances, the endpoint registers location data via known methods of triangulation or global positioning system (GPS), and the location of the endpoint may be used to determine if a condition (e.g., a countries policy towards privacy information) prevents or allows delivery, encryption, or display of the information. Combinations of citizenship and location (e.g., home country versus guest in country) can be use to determine if the information can be received or rendered. In addition to citizenship and location information, company affiliation can also be a factor.

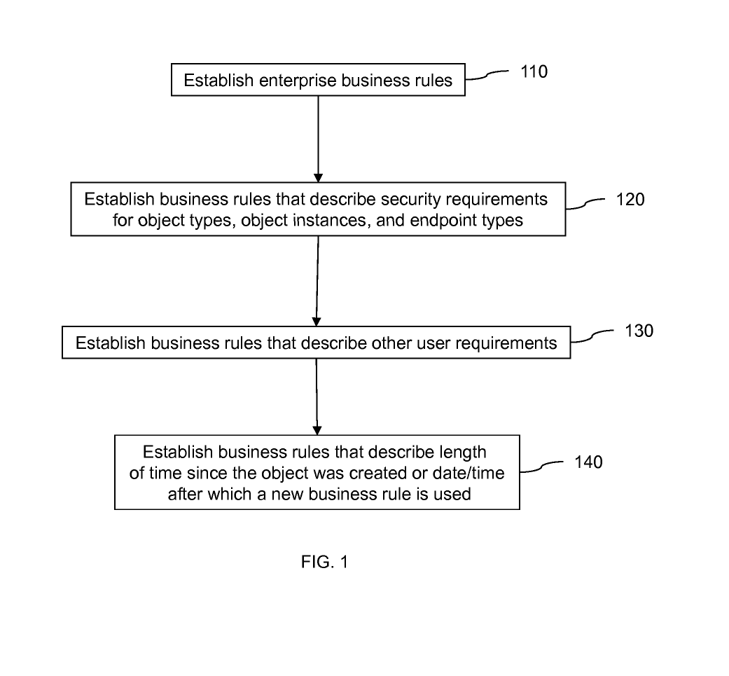

FIG. 1 is a flow diagram illustrating a preparation phase according to an embodiment of the invention. Enterprise business rules which describe the Enterprise's common security requirements for each information object type for each endpoint type are established 110. In at least one embodiment, the rules are established by a system administrator. For each type of information object, the required endpoint attributes are defined, e.g., endpoint OS patch level, endpoint network attachment type (wired or wireless), and/or multi-threading.

Individual business rules which describe additional security requirements for each information object type and object instance and for each type of endpoint are established 120. For each information object type, additional required endpoint attributes are defined, e.g., endpoint must be authenticated to the corporate authentication system. For each specific information object instance, additional required endpoint attributes are defined, e.g., endpoint must be a desktop computer.

Business rules that describe other user requirements are established 130, e.g., user has signed a non-disclosure agreement, and/or user is a U.S. citizen. In at least one embodiment, business rules are established that describe the length of time since the information object was created or the date/time after which a new business rule are used 140.

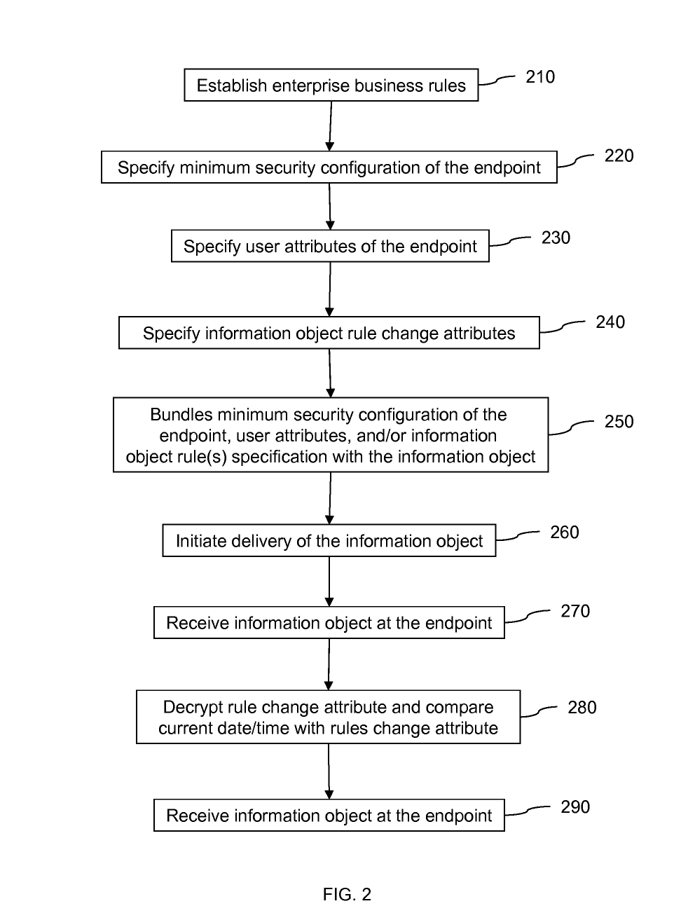

FIG. 2 is a flow diagram illustrating an operational phase according to an embodiment of the invention. In at least one embodiment, items 210-260 are performed by the entity that created the information object; and, items 270-290 are performed by the entity that the information object is sent to. An information object is created and optionally encrypted 210 by the information object creator; and, the minimum security configuration of the endpoint is specified 220. In at least one embodiment, the minimum security configuration can be specified in one of three ways. First, the information object creator can specify the endpoint configuration, for example, from a checkbox list (e.g., no missing high severity patches, antivirus is running, OS is Windows™ 7 (available from Microsoft™, Redmond, Wash., U.S.) or better. Second, the creator can observe the security label on the documents in the information object (e.g., Company Confidential) and then based on predefined rules contained in the creator-side endpoint, the required endpoint configuration is specified. Third, the creator obtains the required endpoint configuration from the Enterprise's standard rule base.

The user attributes of the endpoint is specified 230. In at least one embodiment, this can be specified in one of three ways. First, the information object creator specifies the user (of the endpoint) attributes, for example, from a checkbox list (e.g., user is listed in the company directory, listed in the non-disclosure list, logged-in to the endpoint with a company employee ID (not a contractor ID)). Second, the creator-side component observes the security label on the documents (e.g., Company Confidential) and then based on predefined rules contained in the creator-side endpoint, the required user (of the endpoint) attributes are specified. In at least one embodiment, the creator-side component is a hardware component (e.g., a processor) connected to or resident on a server that applies the extensible set of security attributes and associated rules to the object. Third, the creator-side component obtains from the Enterprise's standard rule base the required user (of the endpoint) attributes.

The information object rule change attributes are specified 240. In at least one embodiment, this can be specified in one of three ways. First, the information object creator can specify the rule and the time (either duration or time/date) of rule invocation, for example, from a checkbox list (e.g., only people with company supplied laptop endpoints can open the information object until 3 months from now, after which it can be opened by any company owned endpoint). Second, the creator-side component observes the security label on the documents (e.g., Company Confidential) and then based on predefined rules contained in the creator-side endpoint, the new information object rule and the time of rule invocation is defined. Third, the creator-side component obtains from the Enterprise's standard rule base the required new information object rule and the time of rule invocation.

In at least one embodiment of the invention, the creator-side component cryptographically protects and bundles the minimum security configuration of the endpoint, the user attributes, and/or the information object rule(s) specification with the information object 250 and initiates delivery of the information object 260. In at least one embodiment, the creator-side component is connected to a program that conveys information objects (e.g., an email program).

The information object is received at the endpoint 270, for example, with the endpoint receiver, which is connected to or resident on the endpoint processor. The endpoint processor decrypts the information object's rule change attribute and compares the current date/time with the rules change attributes 280. If one or more rule changes are needed based on the current date/time and the rules change attributes, then the new information object rule(s) are made active. Receiver-side endpoint determination of the current date/time can be implemented using a variety of means, including obtaining the date/time from the endpoint, obtaining the date/time from a network resource using network time protocol (NTP), obtaining the date/time from an internet source such as www.time.gov, and/or obtaining the date/time from a trusted source using various levels of authentication (e.g., destination, source, strong, weak, etc.) to validate the identity of the source as well as integrity to protect the date/time from modification between the authoritative source and the endpoint. Multiple object rule change attributes can be specified. For example, the object can only be opened by a company-owned laptop for next 3 months; the object can be opened by any company-owned endpoint for months 4 to 6 months; and, object can be opened by any endpoint (e.g, company-owned or personally owned) after 6 months.

The endpoint processor decrypts the endpoint's minimum security specification 290. If the endpoint configuration is better than or equal to the minimum security requirement, then the receive-side endpoint decrypts the user attribute security specification. Specifically, the receiver-side compares the user's attributes with the required user attributes, and if acceptable, then the information object is “opened”. If the endpoint configuration is less than the minimum security requirement, then the system provides information to the user, e.g., what the user must do to increase the security of the endpoint.

In at least one embodiment of the invention, the functions of the preparation phase (items 110-140) and/or operational phase (items 210-290) may be performed in the endpoints and/or in a centralized entity. For example, the methods and systems herein may be embodied within a central administration structure that holds all of the rules. Thus, the entity creating the information object obtains business rules from the central administrative system and associates the business rules with the information object. In another embodiment, the entity creating the information object forwards the information object to the central site; and, the central site associates the rules with the information object. The central site returns the information object to the creating entity and/or forwards the information object toward the destination endpoint.

In another embodiment of the invention, the methods and systems herein may be embodied within a distributed structure. Thus, the endpoint contains all needed rules and associates the appropriate rule(s) with the information object. The various embodiments will have different rules and attributes, e.g., performance, security, flexibility, robustness, but the method steps would still be accomplished.

Other example business rules include a rule specifying that team rooms designated as containing confidential information cannot be accessed by endpoints that are not registered in the Enterprise's endpoint registration database. Another example rule specifies that team rooms designated as containing confidential information cannot be accessed by endpoints that do not have an operational antivirus program using antivirus signatures less than 7 days old. Yet another example rule specifies that team rooms designated as containing government export controlled information cannot be accessed by endpoints that do not have an operational antivirus program using antivirus signatures less than 7 days old or whose owner/user of the endpoint is not a U.S. citizen currently present in the U.S.

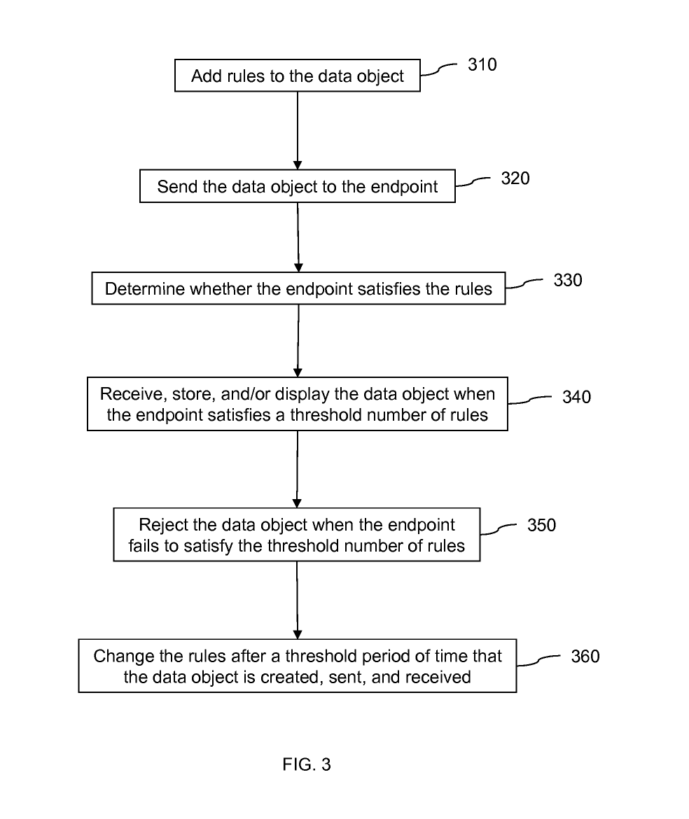

FIG. 3 is a flow diagram illustrating a method for sending a data object to an endpoint according to another embodiment of the invention. Rules (also referred to herein as “business rules”) are added to the data object with a processor 310. As used herein, the terms “add”, “added”, and “adding” include tagging, linking, associating, and appending. In at least one embodiment, the data object is an electronic data file (e.g., a software application); and, the rules are metadata.

The rules can include a requisite endpoint attribute (also referred to herein as the “minimum security configuration at the endpoint”) and/or a requisite user attribute of the endpoint. In at least one embodiment of the invention, the requisite endpoint attribute includes an approved operating system, an approved operating system patch level, an approved antivirus application, a wired connection to a network, a virtual private network tunnel that is terminated at a specific remote access server, an active connection to only one of the internet and a network, registration with a device registration database, an approved physical type, and/or a multi-threaded system. In at least one embodiment, the requisite user attribute of the endpoint includes authentication to a central server, an approved role, signing of a non-disclosure agreement, and/or citizenship of an approved country. The approved role can be based on a person's employment relationship and can include job tasks, physical location, organizational location, training, defined responsibilities, access to physical systems, access to logical systems, and/or any other attribute with respect to the job.

The data object is sent to the endpoint with the added rules 320. In at least one embodiment of the invention, the data object is sent to the endpoint with a communications module, wherein the communications module is a hardware component connected to or resident on the processor. As used herein, the term “connected” includes operationally connected, logically connected, in communication with, physically connected, engaged, coupled, contacts, linked, affixed, and attached.

The method determines whether the endpoint satisfies the rules 330. In at least one embodiment of the invention, a rule-analyzing module determines whether the endpoint satisfies the rules, wherein the rule-analyzing module is a hardware component connected to or resident on the processor. In another embodiment, the rule-analyzing module is a hardware component connected to or resident on the endpoint. In at least one embodiment, the data object is sent to the endpoint before it is determined whether the endpoint satisfies the rules. In another embodiment, the data object is sent to the endpoint after it is determined whether the endpoint satisfies the rules.

When the endpoint satisfies a threshold number of the rules (e.g., 1, all) the data object is received, stored, and/or displayed at the endpoint 340. A threshold which must be satisfied can be composed of one or more thresholds (rules), each of which must be satisfied. In at least one embodiment, the data object is received by a receiver, stored in at least one memory device with a storage management module, and/or displayed with a display (e.g., monitor). In at least one embodiment, the receiver, storage management module, and display are hardware components connected to the rule-analyzing module.

In at least one embodiment of the invention, the data object is rejected (not received, stored, or displayed at the endpoint) when the endpoint fails to satisfy the threshold number of the rules 350. In at least one embodiment, the rules are changed after a threshold period of time that the data object is at least one of created, sent, and received 360. The rules are changed by adding, removing, and/or modifying at least one of the rules. An example of a more restrictive change is that the eighth rule can be changed to specify that after 1 month the endpoint must be one of 20 specified physical types; after 2 months the endpoint must be one of 10 specified physical types; and, after 3 months the endpoint must be one of 5 specified physical types. In at least one embodiment, the data object is rejected by the receiver, storage management module, and/or display; and, the rules are changed by the processor.

In at least one embodiment of the invention, the data object is deleted, modified, copied, and/or sent from the endpoint after a second threshold period of time after the data object is created, sent, and/or received. The second threshold period of time can be equal to or different than the threshold period of time for changing the rules.

In another embodiment, the endpoint is prohibited from sending viewing, modifying, printing, and/or receiving the data object when the endpoint does not satisfy a second threshold number of the rules (equal to or different from the first threshold number).

In yet another embodiment, when the endpoint fails to satisfy the threshold number of rules, the endpoint is provided with (e.g., by the rule-analyzing module via the communications module) the rule(s) that the endpoint failed to satisfy and/or instructions to be performed in order to satisfy the rule(s) that the endpoint failed to satisfy.

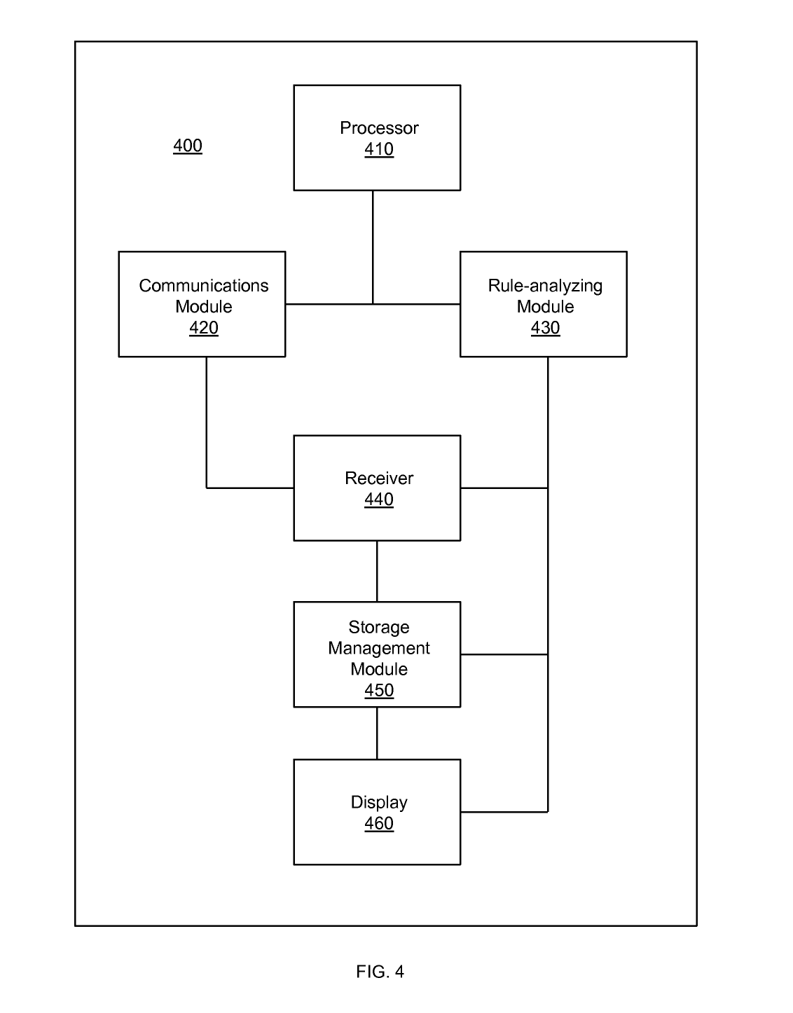

FIG. 4 illustrates a system 400 for sending a data object to an endpoint according to an embodiment of the invention. The system 400 includes a processor 410 for adding rules to the data object, wherein the rules including a requisite endpoint attribute and/or a requisite user attribute of the endpoint. The processor 410 can include change rules (also referred to herein as “change attributes”) for changing the rules after a threshold period of time that the data object is created, sent, and/or received. The processor 410 is connected to a communications module 420 for sending the data object (with the added rules) to the endpoint.

The processor 410 is also connected to a rule-analyzing module 430 that compares attributes of the endpoint to the rules to determine whether the endpoint satisfies the rules. The rule-analyzing module 430 can determine whether the endpoint satisfies the rules before or after the data object is sent to the endpoint. In at least one embodiment, the rule-analyzing module 430 is resident on the processor 410. In another embodiment, the rule-analyzing module 430 is resident on the endpoint.

The rule-analyzing module 430 is connected to a receiver 440, a storage management module 450, and/or a display 460. The receiver 440 receives the data object when the endpoint satisfies a threshold number (e.g., 1; all) of rules. In at least one embodiment, the receiver 440 is connected to a rules database and receives the rules. The receiver 440 can also receive a changed rule after a threshold period of time that the data object is created, sent, and/or received. In addition, the receiver 440 can also receive a rule that the endpoint failed to satisfy and/or instructions to be performed in order to satisfy the rule that the endpoint failed to satisfy when the endpoint fails to satisfy the threshold number of rules.

The storage management module 450 stores the data object when the endpoint satisfies a threshold number (e.g., 1; all) of rules; and, the display 460 displays the data object at the endpoint when the endpoint satisfies a threshold number (e.g., 1; all) of rules. The storage management module 450 can delete the data object, modify the data object, copy the data object, and/or send the data object from the endpoint after a threshold period of time after the data object is created, sent, and/or received.

When the endpoint fails to satisfy the threshold number of rules, the rule-analyzing module 430 can provide the endpoint with the rule(s) that the endpoint failed to satisfy and/or instructions to be performed in order to satisfy the rule(s) that the endpoint failed to satisfy. The rule-analyzing module 430 can also prevent the endpoint from sending the data object when the endpoint does not satisfy the threshold number of rules.

Another embodiment of the invention includes a rules database connected to the rule-analyzing module 430, wherein the rules database includes the rules. In at least one embodiment, the rules database is connected to the processor 410. The rules database can be connected to or resident on the endpoint.

An embodiment of the invention provides a system for sending a data object to an endpoint. The system includes a means for determining whether the endpoint satisfies the rules (e.g., the rule-analyzing module 430) and a means for receiving (e.g., the receiver 440) the data object when the endpoint satisfies a threshold number of rules (e.g., 1 rule, all rules). The system further includes a means for storing (e.g., the storage management module 450) the data object when the endpoint satisfies the threshold number of rules, and a means for displaying (e.g., the display 460) the data object at the endpoint when the endpoint satisfies the threshold number of rules.

In at least one embodiment of the invention, the means for determining whether the endpoint satisfies the rules prevents the endpoint from sending the data object when the endpoint does not satisfy the threshold number of rules. The means for receiving can receive a changed rule after a threshold period of time that the data object is created, sent, and/or received. The means for receiving can also receive a rule that the endpoint failed to satisfy and/or instructions to be performed in order to satisfy the rule that the endpoint failed to satisfy when the endpoint fails to satisfy the threshold number of rules. The means for storing can delete the data object, modify the data object, copy the data object, and/or send the data object from the endpoint after a threshold period of time after the data object is created, sent, and/or received.

At least one embodiment of the invention further includes a means for adding rules to the data object (e.g., the processor 410), wherein the means for adding the rules to the data object can change the rules after a threshold period of time that the data object is created, sent, and/or received. Another embodiment of the invention includes a means for storing the rules (e.g., the rules database) connected to the means for adding rules to the data object and/or the means for determining whether the endpoint satisfies the rules. Yet another embodiment of the invention includes a means for sending the data object (with the added rules) to the endpoint (e.g., the communications module 420) connected to the means for adding rules to the data object.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, portable computer diskette, hard disk, random access memory (RAM), read-only memory (ROM), erasable programmable read-only memory (EPROM or Flash memory), optical fiber, portable compact disc read-only memory (CD-ROM), optical storage device, magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of at least one programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

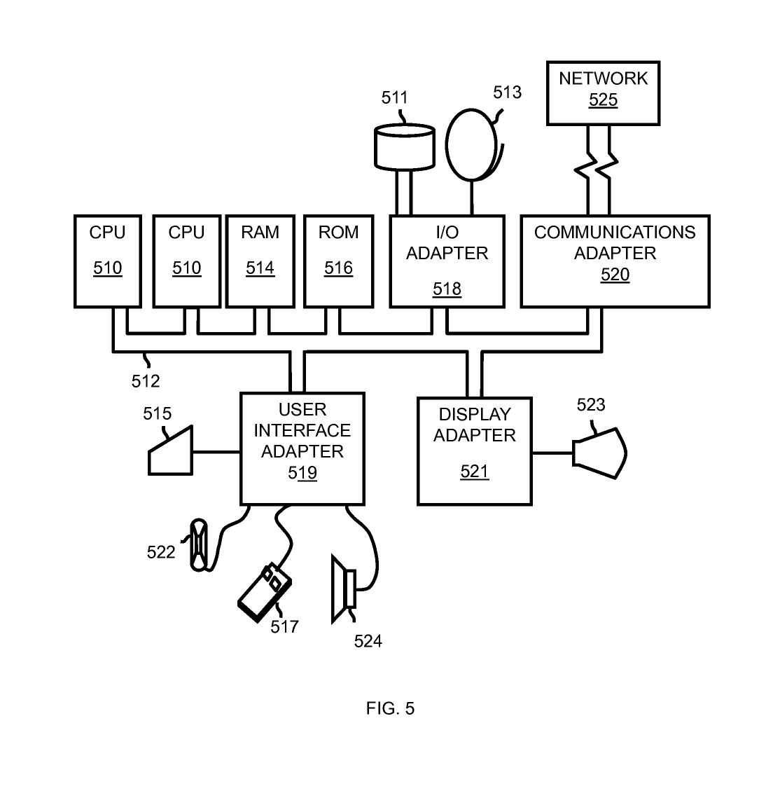

Referring now to FIG. 5, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 510. The CPUs 510 are interconnected with system bus 512 to various devices such as a random access memory (RAM) 514, read-only memory (ROM) 516, and an input/output (I/O) adapter 518. The I/O adapter 518 can connect to peripheral devices, such as disk units 511 and tape drives 513, or other program storage devices that are readable by the system. The system can read the inventive instructions on the program storage devices and follow these instructions to execute the methodology of at least one embodiment of the invention. The system further includes a user interface adapter 519 that connects a keyboard 515, mouse 517, speaker 524, microphone 522, and/or other user interface devices such as a touch screen device (not shown) to the bus 512 to gather user input. Additionally, a communication adapter 520 connects the bus 512 to a data processing network 525, and a display adapter 521 connects the bus 512 to a display device 523 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

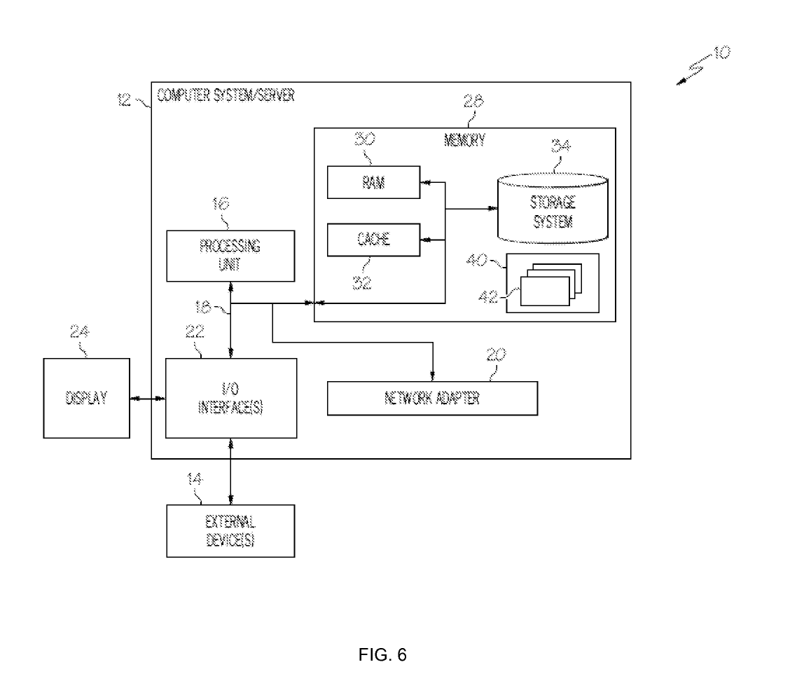

Referring now to FIG. 6, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

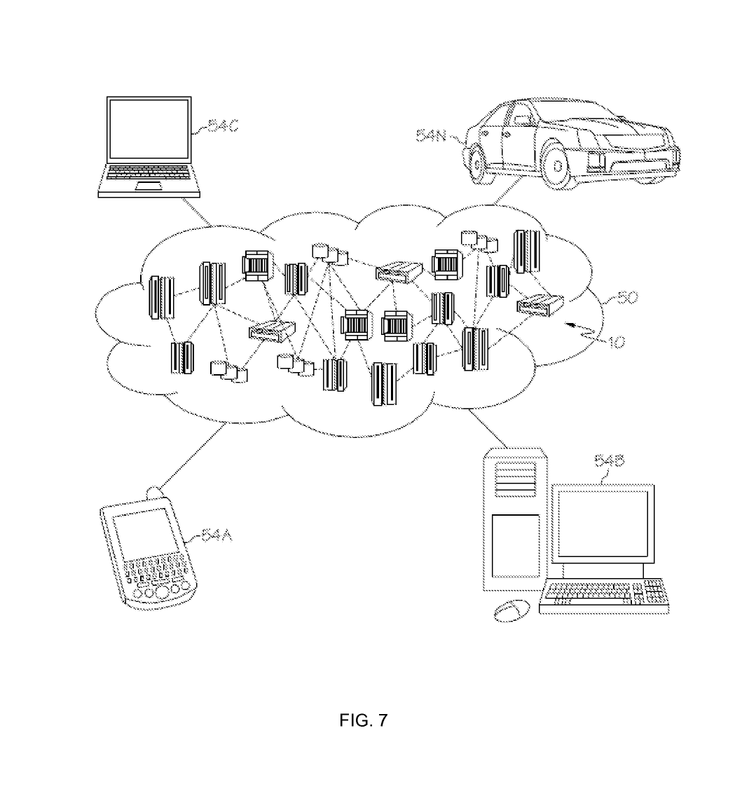

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

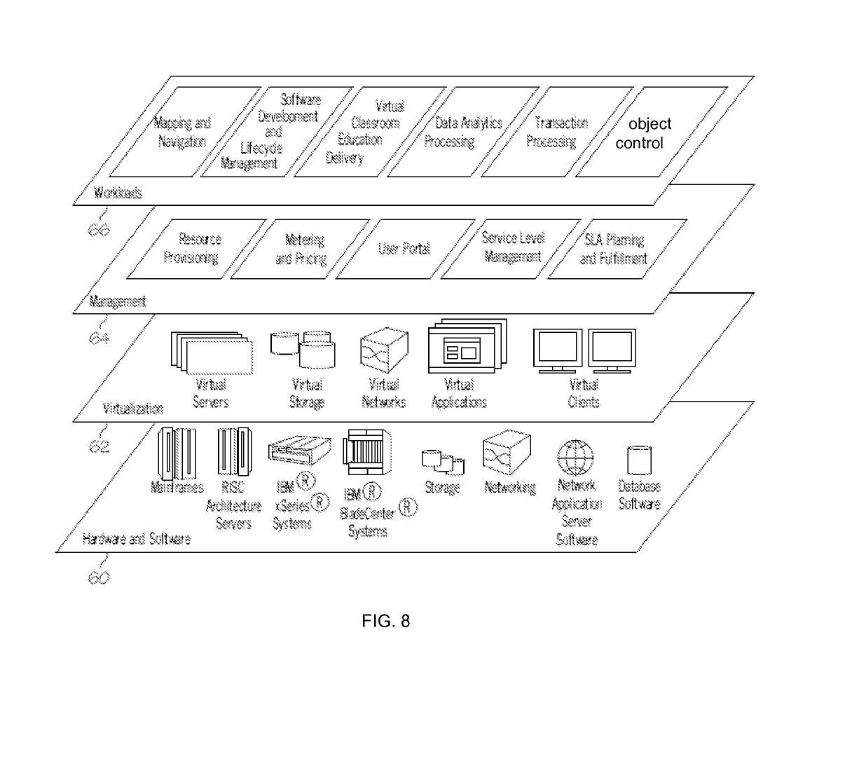

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and object control.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for sending a data object to an endpoint, said method comprising:
adding rules to the data object with a processor, the rules including at least one of:
a requisite endpoint attribute, and
a requisite user attribute of the endpoint;
sending the data object to the endpoint with a communications module;
determining whether the endpoint satisfies the rules with a rule-analyzing module; and
at least one of receiving the data object, storing the data object in a memory device, and displaying the data object on a display at the endpoint when the endpoint satisfies a threshold number of rules.

2. The method according to claim 1, further comprising changing at least one of the rules after a threshold period of time that the data object is at least one of created, sent, and received.

3. The method according to claim 1, further comprising, at least one of deleting the data object, modifying the data object, copying the data object, and sending the data object from the endpoint after a threshold period of time after the data object is at least one of created, sent, and received.

4. The method according to claim 1, further comprising prohibiting the endpoint from sending the data object when the endpoint does not satisfy the threshold number of rules.

5. The method according to claim 1, further comprising, when the endpoint fails to satisfy the threshold number of rules, providing the endpoint with at least one of:
a rule that the endpoint failed to satisfy; and
instructions to be performed in order to satisfy the rule that the endpoint failed to satisfy.

6. The method according to claim 1, wherein the requisite endpoint attribute includes at least one of:
an approved operating system;
an approved operating system patch level;
an approved antivirus application;
an approved connection to a network;
an approved virtual private network tunnel that is terminated at a specific remote access server;
an approved active connection to only one of the internet and a non-internet network;
an approved registration of the endpoint within a device registration database;
an approved physical type of the endpoint; and
an approved multi-threaded system.

7. The method according to claim 1, wherein the requisite user attribute of the endpoint includes at least one of:
an approved authentication to a central server;
an approved role;
an approved signing of a non-disclosure agreement; and
citizenship of an approved country.

8. The method according to claim 7, wherein the approved role includes at least two of job tasks, physical location, organizational location, training, responsibilities, access to physical systems, and access to logical systems.

9. A method for sending a data object to an endpoint, the data object comprising rules, the rules comprising at least one of a requisite endpoint attribute and a requisite user attribute of the endpoint, said method comprising:
determining whether the endpoint satisfies the rules with a rule-analyzing module; and
at least one of receiving the data object with a receiver when the endpoint satisfies a threshold number of rules, storing the data object in a memory device when the endpoint satisfies a threshold number of rules, and displaying the data object on a display at the endpoint when the endpoint satisfies a threshold number of rules.

10. The method according to claim 9, further comprising changing at least one of the rules after a threshold period of time that the data object is at least one of created, sent, and received.

11. The method according to claim 9, further comprising at least one of deleting the data object, modifying the data object, copying the data object, and sending the data object from the endpoint after a threshold period of time after the data object is at least one of created, sent, and received.

12. The method according to claim 9, further comprising prohibiting the endpoint from receiving the data object when the endpoint does not satisfy the threshold number of rules.

13. The method according to claim 9, further comprising, when the endpoint fails to satisfy the threshold number of rules, receiving at least one of:
a rule that the endpoint failed to satisfy; and
instructions to be performed in order to satisfy the rule that the endpoint failed to satisfy.

14. The method according to claim 9, wherein the requisite endpoint attribute includes at least one of:
an approved operating system;
an approved operating system patch level;
an approved antivirus application;
an approved connection to a network;
an approved virtual private network tunnel that is terminated at a specific remote access server;
an approved active connection to only one of the internet and a non-internet network;
an approved registration of the endpoint within a device registration database;
an approved physical type of the endpoint; and
an approved multi-threaded system.

15. The method according to claim 9, wherein the requisite user attribute of the endpoint includes at least one of:
an approved authentication to a central server;
an approved role;
an approved signing of a non-disclosure agreement; and
citizenship of an approved country.

16. The method according to claim 15, wherein the approved role includes at least two of job tasks, physical location, organizational location, training, responsibilities, access to physical systems, and access to logical systems.

17. A method for sending a data object to an endpoint, said method comprising:
adding rules to the data object with a processor, the rules including at least one of:
a requisite endpoint attribute, and
a requisite user attribute of the endpoint, the requisite user attribute of the endpoint including an approved role;
sending the data object to the endpoint with a communications module;
determining whether the endpoint satisfies the rules with a rule-analyzing module;
at least one of receiving the data object, storing the data object in a memory device, and displaying the data object on a display at the endpoint if the endpoint satisfies a threshold number of rules; and
changing at least one of the rules with the processor after a threshold period of time that the data object is at least one of created, sent, and received.

18. The method according to claim 17, further comprising providing the endpoint with at least one of a rule that the endpoint failed to satisfy and instructions to be performed in order to satisfy the rule that the endpoint failed to satisfy when the endpoint fails to satisfy the threshold number of rules.

19. The method according to claim 17, wherein the requisite endpoint attribute includes:
an approved operating system;
an approved operating system patch level;
an approved antivirus application;
an approved connection to a network;
an approved virtual private network tunnel that is terminated at a specific remote access server;
an approved active connection to only one of the internet and a non-internet network;
an approved registration of the endpoint within a device registration database;
an approved physical type of the endpoint; and
an approved multi-threaded system.

20. The method according to claim 17, wherein the requisite user attribute of the endpoint includes:
an approved authentication to a central server;
an approved signing of a non-disclosure agreement; and
citizenship of an approved country.

21. The method according to claim 7, wherein the approved role includes job tasks, physical location, organizational location, training, responsibilities, access to physical systems, and access to logical systems.

22. A method for sending a data object to an endpoint, said data object comprising rules, the rules comprising at least one of a requisite endpoint attribute and a requisite user attribute of the endpoint, the method comprising:
determining whether the endpoint satisfies the rules with a rule-analyzing module; at least one of receiving the data object with a receiver when the endpoint satisfies a threshold number of rules, storing the data object in a memory device when the endpoint satisfies a threshold number of rules, and displaying the data object on a display at the endpoint when the endpoint satisfies a threshold number of rules;
receiving at least one of a rule that the endpoint failed to satisfy and instructions to be performed in order to satisfy the rule that the endpoint failed to satisfy when the endpoint fails to satisfy the threshold number of rules; and
at least one of deleting the data object, modifying the data object, copying the data object, and sending the data object after a threshold period of time after the data object is at least one of created, sent to the endpoint, and received by the endpoint.

23. The method according to claim 22, wherein the requisite endpoint attribute includes:
an approved operating system;
an approved operating system patch level;
an approved antivirus application;
an approved connection to a network;
an approved virtual private network tunnel that is terminated at a specific remote access server;
an approved active connection to only one of the internet and a non-internet network;
an approved registration of the endpoint within a device registration database;
an approved physical type of the endpoint; and
an approved multi-threaded system.

24. The method according to claim 22, wherein the requisite user attribute of the endpoint includes:
an approved authentication to a central server;
an approved role;
an approved signing of a non-disclosure agreement; and
citizenship of an approved country.

25. The method according to claim 15, wherein the approved role includes job tasks, physical location, organizational location, training, responsibilities, access to physical systems, and access to logical systems.
